(19) United States
(12) Patent Application Publication
(10) Pub. No.: US 2023/0044510 A1
(43) Pub. Date: Feb. 9, 2023

(54) Silylation of Copolymers Comprising Para-Methylstyrene: Synthesis and Composites Thereof

(71) Applicant: ExxonMobil Chemical Patents Inc., Baytown, TX (US)

(72) Inventors: Tzu-Pin Lin, Seabrook, TX (US); Gang Huang, Shanghai (CN); Jo Ann M. Canich, Houston, TX (US); Irene C. Cai, Webster, TX (US); Brian J. Rohde, Houston, TX (US)

(21) Appl. No.: 17/860,720

(22) Filed: Jul. 8, 2022

Related U.S. Application Data
(60) Provisional application No. 63/221,232, filed on Jul. 13, 2021.

(51) Int. Cl. C08L 23/14; C08L 23/08

(52) U.S. Cl. CPC C08L 23/145; C08L 23/0838

(57) ABSTRACT

A composition, including: a copolymer including units derived from ethylene, one or more α-olefins, one or more substituted styrene compounds, and a pendant alkoxy silane group. A method was disclosed to incorporate pendant alkoxy silyl groups onto the benzylic positions. The silane-functionalized polymers show ability to cure with water. Additionally, blends of silane-functionalized polymers exhibit improved filler acceptance.

### CROSS REFERENCE TO RELATED APPLICATIONS

This application claims priority to U.S. Patent Application 63/221,232 filed Jul. 13, 2021, the entirety of which is hereby incorporated by reference.

This application is related by subject matter to PCT Patent Publication WO2021/262838, filed Jun. 23, 2021.

### FIELD

Exemplary embodiments described herein relate to the chemical modification of polymers comprising benzylic functionalities, and new polymers bearing pendant alkoxy silane groups.

### BACKGROUND

Common elastomers are terpolymers of ethylene, propylene, and diene monomer (e.g., ethylidiene norbornene, hexadiene, octadiene, vinyl norbornene, and the like, which are generally referred to as EPDMs. Ordinary ethylene propylene (EP) elastomers (that typically lack a diene) can be cured through use of curatives such as organic peroxides.

Lithiation reactions of a para-methylstyrene containing polymer have been described U.S. Pat. Nos. 5,543,484, 5,866,659, and 6,015,862, and international patent publication WO1996/016096.

### SUMMARY

A composition, comprising: a copolymer including units derived from ethylene, one or more α-olefins, one or more substituted styrene compounds, and a pendant alkoxy silane group.

The composition, wherein the one or more substituted styrene compound includes para-methylstyrene, and the one or more α-olefins includes propylene.

The composition, wherein the composition is 30-40 wt % C₂, 45-55 wt % C₃, 10-20 wt % para-methylstyrene derived units, and 0.5-2 wt % of the pendant alkoxy silane group, based on the weight of the copolymer.

The composition, wherein the alkoxy silane group has the formula RₙSiX₍₄₋ₙ₎, R is an organic moiety that is an alkyl, aromatic, or combination thereof, X is an alkoxy moiety, and n is a whole number ranging from 1 to 3.

The composition, wherein X is ethoxy.

The composition, wherein X is methoxy or any alkoxy.

The composition, wherein the substituted styrene compound is represented by the formula:

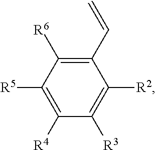

wherein each R², R³, R⁴, R⁵ and R⁶ is independently hydrogen or a C₁ to C₂₀ hydrocarbyl group, wherein at least one of R², R³, R⁴, R⁵ and R⁶ is not hydrogen.

A method, comprising: combining ethylene, one or more α-olefins, and one or more substituted styrene compounds with n-BuLi, and then an chloroalkoxysilane, under reaction conditions, to form a copolymer bearing a pendant alkoxy silane group.

The method, wherein the one or more substituted styrene compound includes para-methylstyrene, and the one or more α-olefins includes propylene.

The method, wherein the chloroalkoxysilane is Cl—Si(OEt)₃.

The method, further comprising at least partially curing the copolymer bearing pendant alkoxy silane groups in water.

### BRIEF DESCRIPTION OF THE FIGURES

FIG. 1 depicts before/after rheological behaviors that are consistent with partial crosslinking.

FIG. 2 depicts before/after rheological behaviors that are consistent with partial crosslinking after isolation using wet ethanol.

FIG. 3 describes silica acceptance studies.

FIG. 4 is graph of G′ vs strain comparing a control to exemplary embodiments of the present technological advancement.

FIG. 5 are parts per hundred rubber (phr) images comparing a control to exemplary embodiments of the present technological advancement.

FIG. 5A depicts an EP-PMS, a terpolymer comprised of ethylene/propylene/para-methylstyrene synthesized using a titanium polymerization catalyst.

### DETAILED DESCRIPTION

It is to be understood that the following disclosure describes several exemplary embodiments for implementing different features, structures, and/or functions of the present technological advancement. Exemplary embodiments of components, arrangements, and configurations are described below to simplify the present disclosure; however, these exemplary embodiments are provided merely as examples and are not intended to limit the scope of the invention.

For the purposes of this specification and the claims thereto, the new numbering scheme for the Periodic Table Groups is used as described in Chemical and Engineering News, v. 63(5), pg. 27 (1985). Therefore, a “group 4 metal” is an element from group 4 of the Periodic Table, e.g. Hf, Ti, or Zr.

Synthetic methods have been developed to chemically modify polymers comprising benzylic functionalities, affording novel polymers bearing pedant alkoxysilane groups. These silylated polymers can be cured in water. Additionally, polymer composites thereof show improved silica acceptance.

Polymers bearing pendant silyl groups are highly sought after but challenging to synthesize on a commercial scale. Conventional silylation methods include post-reactor melt-grafting processes that utilize peroxides and vinylsilanes. Unfortunately, these grafting reagents are difficult to handle and remove. Further, the oxidative grafting processes often lead to chain-scission events that alter the molecular weight distributions. To address these limitations, the present technological advancement provides a method that leverages para-methylstyrene as a comonomer amenable to post-polymerization modifications. Polymers containing pendant para-tolyl groups can react with n-butyl lithium and then chloroalkoxysilanes. The silylated polymers can be partially cured with water. Studies on their composites with silica fillers suggest increased silica filler acceptance.

The present technological advancement relates to composition including a copolymer including units derived from ethylene, one or more α-olefins, one or more substituted styrene compounds, and a pendant alkoxy silane group. The composition can include 30-40 wt % C₂, 45-55 wt % C₃, 10-20 wt % para-methylstyrene derived units, and 0.5-2 wt % of pendant alkoxy silane group derived units, based on the weight of the copolymer.

In some examples, the EM-PMS-Si copolymer can include less than or equal to 20 wt % units derived from a substituted styrene compound (“substituted styrene”), or less than or equal to 15 wt % substituted styrene, or less than or equal to 10 wt % substituted styrene, or less than or equal to 5 wt % substituted styrene, or less than or equal to 10 wt % substituted styrene, or less than or equal to 5 wt % substituted styrene, or less than or equal to 3 wt % substituted styrene based on the weight of the EM-PMS-Si copolymer. In some examples, the substituted styrene can be present from 0.1 wt % to 20 wt %, from about 0.1 wt % to about 10 wt %, from about 0.1 wt % to about 5 wt %, or from about 0.1 wt % to about 3 wt %, based on the weight of the EM-PMS-Si copolymer.

The alkoxy silane group can have the formula RₙSiX₍₄₋ₙ₎, wherein R is an organic moiety that is an alkyl, aromatic, or combination thereof, X is an alkoxy moiety, and n is a whole number ranging from 1 to 3. Preferably, X is methoxy, ethoxy, or isopropoxy.

A preferred substituted styrene compound includes those represented by the Formula (I):

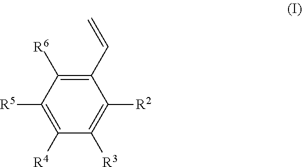

where R², R³, R⁴, R⁵ and R⁶ is independently is hydrogen, or a hydrocarbyl group, such as a C₁ to C₂₀ hydrocarbyl group, such as methyl, ethyl, propyl, butyl, pentyl, hexyl, heptyl, octyl, nonyl, cyclooctyl, cyclododecyl, decyl, undecyl, dodecyl, adamantyl or an isomer thereof, provided that at least one of R², R³, R⁴, R⁵ and R⁶ is not hydrogen, alternately 2, 3, 4, or 5 of R², R³, R⁴, R⁵ and R⁶ are not hydrogen.

In a preferred embodiment of the invention, R⁴ is not hydrogen.

In a preferred embodiment of the invention, R⁴ is a hydrocarbyl group, such as a C₁ to C₂₀ hydrocarbyl group, such as methyl, ethyl, propyl, butyl, pentyl, hexyl, heptyl, octyl, nonyl, cyclooctyl, cyclododecyl, decyl, undecyl, dodecyl, adamantyl or an isomer thereof.

In a preferred embodiment of the invention, R⁴ is a hydrocarbyl group, such as a C₁ to C₂₀ hydrocarbyl group, such as methyl, ethyl, propyl, butyl, pentyl, hexyl, heptyl, octyl, nonyl, cyclooctyl, cyclododecyl, decyl, undecyl, dodecyl, adamantyl or an isomer thereof and R², R³, R⁵ and R⁶ are hydrogen.

Preferably the substituted styrene is a para-alkyl styrene, where the alkyl is a C₁ to C₄₀ alkyl, such as methyl, ethyl, propyl, butyl, pentyl, hexyl, heptyl, octyl, nonyl, cyclooctyl, cyclododecyl, decyl, undecyl, dodecyl, adamantyl or an isomer thereof. More preferably, the substituted styrene is para-methyl styrene.

In embodiments of the EM-PMS-Si copolymer: 1) the ethylene derived units are present at 20 to 80 wt % (alternately 40 wt % to 80 wt %, alternately 40 wt % to 75 wt %), 2) the alpha-olefin (such as propylene) derived units are present at 20 to 79.8 wt %, (alternately 30 wt % to 70 wt %, alternately 35 wt % to 60 wt %), 3) the substituted styrene derived units are present at 0.1 to 40 wt % (alternately 0.3 wt % to 10 wt %, alternately 0.3 wt % to 5 wt %), based upon the weight of the copolymer; and 4) the pendant alkoxy silane group is present at 0.1 to 5 wt % (alternately, 0.1 to 3 wt %, alternatively, 0.5 to 3 wt %) based on the weight of the copolymer.

### Synthesis and Polymerization Process

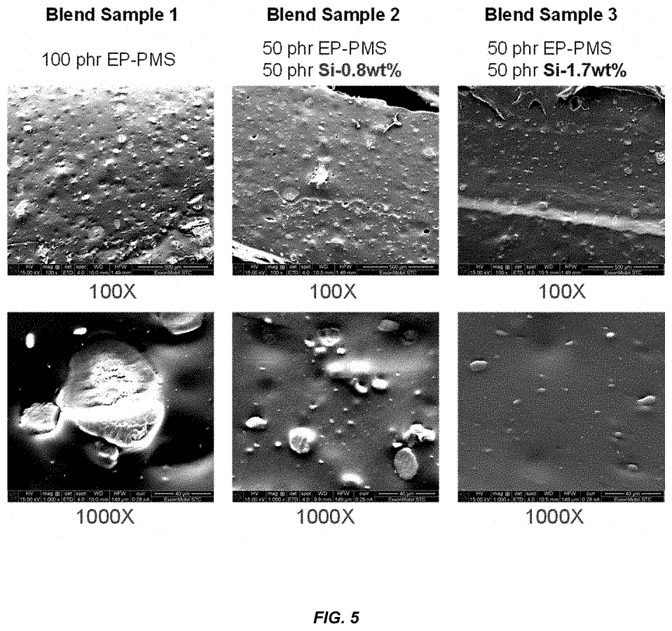

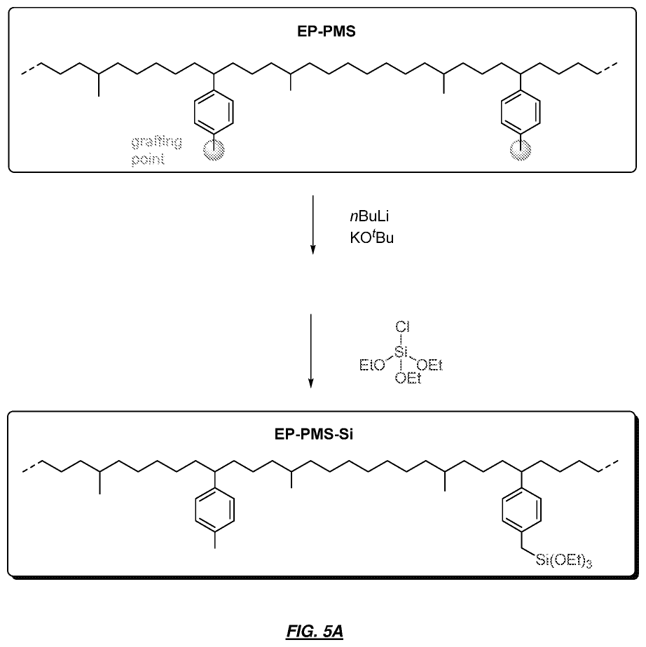

EP-PMS, as depicted in FIG. 5A, is a terpolymer comprised of ethylene/propylene/para-methylstyrene synthesized using a titanium polymerization catalyst. Further information on EP-PMS is found in PCT Patent Application PCT/US2021/038664. The composition and basic polymer attributes are listed in Table 1.

A polymerization method can include combining ethylene, one or more α-olefins, and one or more substituted styrene compounds to afford terpolymers of ethylene/α-olefin/substituted styrene. The terpolymer is then allowed to react with combinations of n-BuLi, KOtBu, tBuLi, or potassium bis(trimethylsilyl)amide, followed by a haloalkoxysilane such as chlorotriethoxysilane, to form a copolymer bearing a pendant alkoxy silane group.

Haloalkoxysilane is Si(R)a(X)b(OR′)c where a+b+c=4. R and R′ are hydrocarbons. X is a halogen such as F, Cl, Br, or I. Preferably, the haloalkoxysilane can be Cl—Si(OEt)₃, Cl—SiMe(OEt)₂, Br—Si(OEt)₃, Br—SiMe(OEt)₂, Cl—Si(OMe)₃, Cl—SiMe(OMe)₂.

TABLE 1
Polymer compositions

| | M_{w} | Mₙ | PDI | C₂ | C₃ | PMS | PMS-Si | T_{g} |
|---|---|---|---|---|---|---|---|---|
| Sample | (g/mol) | (g/mol) | (Mw/Mn) | wt % | wt % | wt % | wt % | (° C.) |
| EP-PMS | 78,092 | 26,564 | 2.60 | 33.4% | 51.5% | 15.1% | | −48.6 |
| EP-PMS- | — | — | — | 33.2% | 51.4% | 14.6% | 0.8% | −48.6 |
| Si-0.8 wt % | | | | | | | | |
| EP-PMS- | — | — | — | 33.1% | 51.1% | 14.1% | 1.7% | −48.6 |
| Si-1.7 wt % | | | | | | | | |

Synthesis of EP-PMS-Si-0.8 wt %. To a 2 L 3-neck-flask charged with 30 g of the parent polymer (EP-PMS) and a stir bar was added 1 liter of anhydrous hexane. The solution was stirred at room temperature for 12 hours, allowing the polymer to completely dissolve. To this solution was added solid KOtBu (0.86 g). To the mixture was added 2.51 mL of n-BuLi (1.6 M hexane solution) dropwise at room temperature, leading to an orange solution. After stirring at room temperature for 20 minutes, 3.95 mL of Cl—Si(OEt)₃ was added. Stirring for an additional 30 minutes resulted in a colorless solution. The polymer was precipitated in wet ethanol, washed with wet ethanol (300 mL) four times, and dried under vacuum at 40° C. for 3 days. The polymer composition was determined by NMR analyses (see Table 1). GPC data are not included for potential interactions between the silylated polymers and the GPC column.

Synthesis of EP-PMS-Si-1.7 wt %. To a 2 liter 3-neck-flask charged with 30 g of the parent polymer (EP-PMS) and a stir bar was added 1 liter of anhydrous hexane. The solution was stirred at room temperature for 12 hours, allowing the polymer to completely dissolve. To this solution was added solid KOtBu (1.72 g). To the mixture was added 5.03 mL of n-BuLi (1.6 M hexane solution) dropwise at room temperature, leading to an orange solution. After stirring at room temperature for 20 minutes, 7.9 mL of Cl—Si(OEt)₃ was added. Stirring for an additional 30 minutes resulted in a colorless solution. The polymer was precipitated in wet ethanol, washed with wet ethanol (300 mL) four times, and dried under vacuum at 40° C. for 3 days. The polymer composition was determined by NMR analyses (see Table 1). GPC data are not included for potential interactions between the silylated polymers and the GPC column.

The present technological advancement relates to polymerization processes where monomers comprising ethylene, alpha olefin comonomer, and substituted styrene are contacted with a catalyst system comprising an activator and at least one catalyst compound, as described herein. The catalyst compound and activator may be combined in any order, and are combined typically prior to contacting with the monomer.

Polymerization processes of the present technological advancement can be carried out in any manner known in the art. Any suspension, homogeneous, bulk, solution, slurry, or gas phase polymerization process known in the art can be used. Such processes can be run in a batch, semi-batch, or continuous mode. Homogeneous polymerization processes and slurry processes are preferred. (A homogeneous polymerization process is preferably a process where at least 90 wt % of the product is soluble in the reaction media.) A bulk homogeneous process is particularly preferred. (A bulk process is preferably a process where monomer concentration in all feeds to the reactor is 70 volume % or more.) Alternately, no solvent or diluent is present or added in the reaction medium, (except for the small amounts used as the carrier for the catalyst system or other additives, or amounts typically found with the monomer; e.g., propane in propylene).

Preferred polymerizations can be run at any temperature and/or pressure suitable to obtain the desired ethylene polymers. Typical temperatures and/or pressures include a temperature in the range of from about 0° C. to about 300° C., preferably about 20° C. to about 200° C., preferably about 35° C. to about 150° C., preferably from about 40° C. to about 120° C., preferably from about 45° C. to about 80° C.; and at a pressure in the range of from about 0.35 MPa to about 10 MPa, preferably from about 0.45 MPa to about 6 MPa, or preferably from about 0.5 MPa to about 4 MPa.

In a typical polymerization, the run time of the reaction is up to 300 minutes, preferably in the range of from about 5 to 250 minutes, or preferably from about 10 to 120 minutes.

In some embodiments hydrogen is present in the polymerization reactor at a partial pressure of 0.001 to 50 psig (0.007 to 345 kPa), preferably from 0.01 to 25 psig (0.07 to 172 kPa), more preferably 0.1 to 10 psig (0.7 to 70 kPa).

Other additives may also be used in the polymerization, as desired, such as one or more scavengers, promoters, modifiers, reducing agents, oxidizing agents, hydrogen, aluminum alkyls, silanes, or chain transfer agents (such as alkylalumoxanes, a compound represented by the formula AlR₃ or ZnR₂ (where each R is, independently, a C₁-C₈ aliphatic radical, preferably methyl, ethyl, propyl, butyl, penyl, hexyl octyl or an isomer thereof) or a combination thereof, such as diethyl zinc, methylalumoxane, trimethylaluminum, triisobutylaluminum, trioctylaluminum, or a combination thereof).

### EM-PMS-Si Copolymer Properties

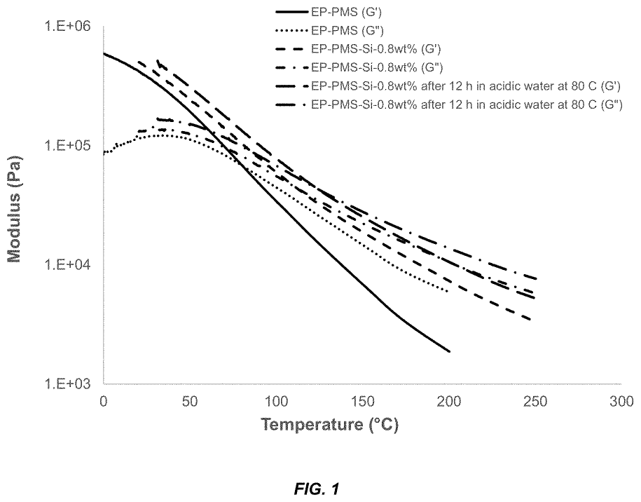

FIG. 1 shows the temperature dependence of viscoelasticity of three samples. For EP-PMS, storage modulus (G′) and loss modulus (G″) for this amorphous polymer crossovers at 80° C., and G′ decreases fast with temperature. The silane-modified polymer EP-PMS-Si-0.8 wt % shows higher modulus with a crossover temperature measured at 110° C., and G′ decline is slower. Treating EP-PMS-Si-0.8 wt % in acidic water at 80° C. for 12 hours further increase the modulus, with the crossover temperature shifted to 123° C. These data suggest that water treatment can crosslink the silane-modified polymer.

### Blends and End Use Applications

The term phr is parts per hundred rubber by weight or “parts,” and is a measure common in the art wherein components of a composition are measured relative to a total of all of the elastomer components. The total phr or parts for all rubber components, whether one, two, three, or more different rubber components is present in a given recipe is always defined as 100 phr. All other non-rubber components are ratioed against the 100 parts of rubber and are expressed in phr. This way one can easily compare, for example, the levels of curatives or filler loadings, etc., between different compositions based on the same relative proportion of rubber without the need to recalculate percents for every component after adjusting levels of only one, or more, component(s). For purposes of this specification, when phr is used with respect to the presence of the ethylene-propylene-diene-substituted styrene copolymer, the reference is made with respect to the total amount of both copolymer and all blend rubber components (one or more than one).

Embodiments of the present technological advancement can further provide an elastomer composition (also referred to as a rubber blend) comprising EADS copolymer compounded with a blend rubber and optional additives. Typically 5 to 40 phr of the copolymer, more preferably from 10 to 30 phr copolymer is present in the elastomer composition.

The blend rubber can include one or more than one rubber (the second or more rubber being referred to as “secondary rubbers”) selected from natural rubbers (“NR”), polyisoprene rubber (“IR”), poly(styrene-co-butadiene) rubber (“SBR”), polybutadiene rubber (“BR”), poly(isoprene-co-butadiene) rubber (“IBR”), styrene-isoprene-butadiene rubber (“SIBR”), butyl rubber, star branched butyl rubber (“SBBR”), poly(isobutylene-co-alkylstyrene), polychloroprene rubber, nitrile rubber, ethylene-propylene rubber (“EPM”), ethylene-propylene-diene rubber (“EPDM”), mixtures thereof and the like. In an embodiment, the blend rubber can include a mixture of at least two of these elastomers. In an embodiment, the blend rubber(s) can contain halogen either by halogenation of the polymer or polymerization of halogen-containing monomers, e.g., polychloroprene, chlorobutyl rubber, bromobutyl rubber, brominated or chlorinated star branched butyl rubber, etc.

In embodiments of the present technological advancement, the blend rubber can comprise a mixture of natural rubber and polybutadiene rubber. The natural rubber being present at from 5 to 80 phr and the polybutadiene rubber at from 5 to 80 phr.

In embodiments of the present technological advancement, the elastomer composition can further comprise a filler, for example, selected from carbon black, modified carbon black, silica, precipitated silica, and the like, and blends thereof. In an embodiment, the elastomer composition can further comprise a chemical protectant, for example, selected from waxes, antioxidants, antiozonants, and the like, and combinations thereof. In an embodiment, the elastomer composition can further comprise a processing oil, resin, or the like, and combinations thereof. In an embodiment, the elastomer composition can further comprise a curing package.

Another embodiment of the present technological advancement provides the vulcanizate obtained by curing the elastomer composition described above. The vulcanizate can be substantially free of staining as determined in accordance with ASTM D-925. The vulcanizate in one embodiment can have a reduced level, be substantially free of or be free of N,N′-disubstituted-para-phenyldiamines.

Another embodiment of the present technological advancement provides an article comprising the vulcanizate. The article can be a tire sidewall, for example, or a tire made with the sidewall comprising the vulcanizate. The tire can further include retreads. In various embodiments, the tire can be a bias truck tire, an off-road tire, or a luxury passenger automobile tire. Alternately or additionally, the article can be a tire tread or a tire made with the tire tread comprising the vulcanizate.

Another embodiment of the present technological advancement provides a process for making a molded article. The process comprises melt mixing the elastomeric composition described above, shaping the mixture into an article, and curing the shaped article to covulcanize the EADS copolymer and the blend rubber.

Another embodiment of the present technological advancement provides a tire sidewall composition comprising a curable composition or vulcanizate of from 10 to 30 phr EADS copolymer; from 20 to 60 phr natural rubber; from 20 to 60 phr polybutadiene rubber; an optional secondary blend rubber selected from IR, SBR, IBR, SIBR, butyl rubber, SBBR, poly(isobutylene-co-alkylstyrene), EPM, EPDM and mixtures thereof; a filler selected from carbon black, modified carbon black, silica, precipitated silica, and blends thereof; a chemical protectant selected from waxes, antioxidants, antiozonants and combinations thereof; an optional processing oil, resin, or combination thereof; and a curing package.

The blend rubber can be any other elastomer, such as, for example, a general purpose rubber in one embodiment. A general purpose rubber, often referred to as a commodity rubber, may be any rubber that usually provides high strength and good abrasion along with low hysteresis and high resilience. These elastomers require antidegradants in the mixed compound because they generally have poor resistance to both heat and ozone.

Further applications of the polymers, rubbers, and/or blends that are also applicable to the present technological advancement are described in U.S. Patent Application 63/044,748, file Jun. 26, 2020, the entirety of which is hereby incorporated by reference.

### Filler Dispersion Studies on Polymer Blends

Blend Sample 1. EP-PMS (100 phr) was compounded in a brabender at 160° C. (60 rpm). Rubbers were added at t=0 min. Amorphous silica (30 phr) was added at t=2.5 min. TsOH—H₂O (2 phr) was added as a solid at t=4.5 min. The total mixing time was 15 minutes.

Blend Sample 2. EP-PMS (50 phr) and EP-PMS-Si-0.8 wt % (50 phr) were compounded in a brabender at 160° C. (60 rpm). Rubbers were added at t=0 min. Amorphous silica (30 phr) was added at t=2.5 min. TsOH—H₂O (2 phr) was added as a solid at t=4.5 min. The total mixing time was 15 minutes.

Blend Sample 3. EP-PMS (50 phr) and EP-PMS-Si-1.7 wt % (50 phr) were compounded in a brabender at 160° C. (60 rpm). Rubbers were added at t=0 min. Amorphous silica (30 phr) was added at t=2.5 min. TsOH—H₂O (2 phr) was added as a solid at t=4.5 min. The total mixing time was 15 minutes.

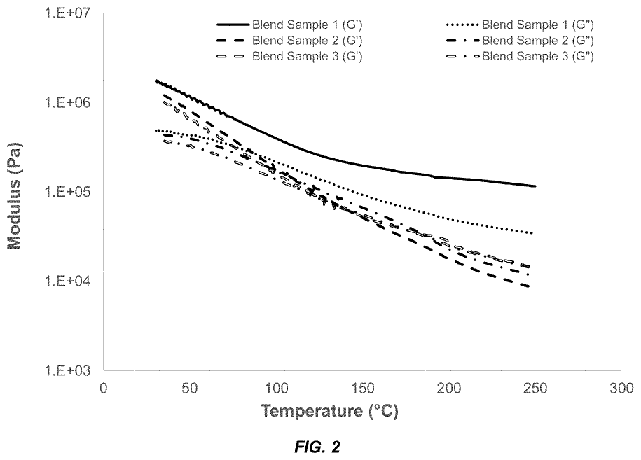

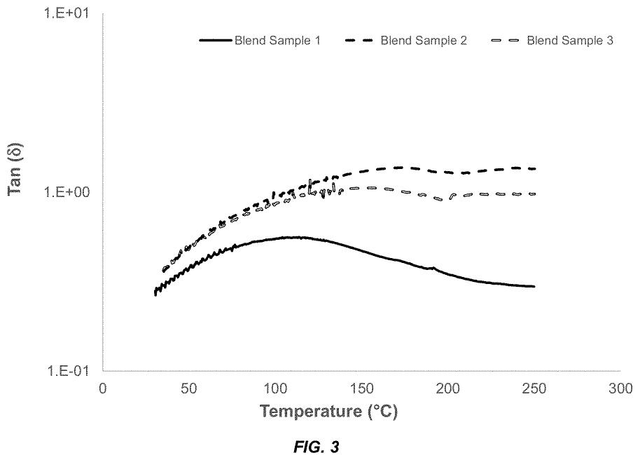

DMTA of the blends. The viscoelastic behaviors of the polymer blends were studied by DMTA methods. FIG. 2 and FIG. 3 show the dependence of modulus on temperatures. Due to ample filler-filler interaction in Blend Sample 1, the G′ of Blend Sample 1 is higher than that of Blend Sample 2 and 3. The polar group in EP-PMS-Si can improve the dispersion of silica, avoiding aggregation in Blend Sample 2 and 3, leading to lower G′ values. Loss factor tan δ dependence on temperature shows Blend Sample 1 behaves solid-like (tan δ<1) during the whole testing temperature range, while blend 2 and 3 show tan δ increases with temperature from less than 1 to higher than 1, in agreement with better silica dispersion in Blend Sample 2 and 3.

The data for blend samples 1, 2, and 3 is included in Table 2.

TABLE 2

| | Blend | Blend | Blend |
|---|---|---|---|
| Sample | Sample 1 | Sample 2 | Sample 3 |
| EP-PMS | 100 phr | 50 phr | 50 phr |
| EP-PMS-Si-0.8 wt % | | 50 phr | |
| EP-PMS-Si-1.7 wt % | | | 50 phr |
| Silica | 30 phr | 30 phr | 30 phr |
| TsOH-H₂O | 2 phr | 2 phr | 2 phr |

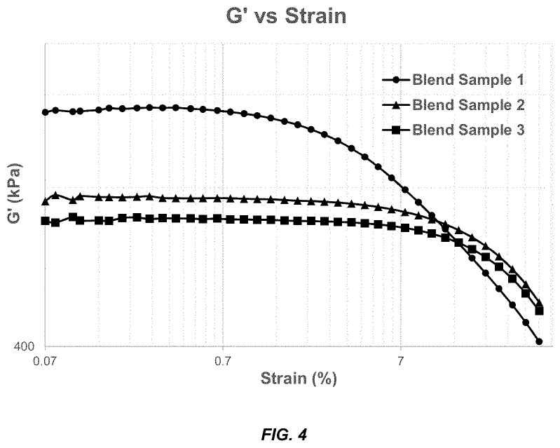

RPA. The strain dependences in G′ were measured at 60° C. under amplitude shear at an oscillatory frequency of 1 Hz. The window of strain sweep was from 0.07% to 50%. FIG. 4 shows G′ dependence on amplitude. The hysteretic breakdown of filler-filler interaction known as Payne effect manifests a decrease in G′ with increasing strain. Blend Sample 2 exhibits a very similar Payne effect as Blend Sample 3, featuring a flat evolution of G′ with increasing strain. In contrast, G′ of Blend Sample 1 shows a steep drop at lower strain, indicating silica particles not very well dispersed.

SEM. FEI Quanta 450 SEM under High Vacuum mode is taken to scan compositional morphology. FIG. 5 shows filler size and dispersion in the blend samples. Blend sample 1 shows largest filler domain size, EP-PMS-Si result in smaller domain size, more Si component in polymer chain can make filler cluster smaller.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A composition, comprising:
a copolymer including units derived from ethylene, one or more α-olefins, one or more substituted styrene compounds, and a pendant alkoxy silane group.

2. The composition of claim 1, wherein the one or more substituted styrene compound includes para-methylstyrene, and the one or more α-olefins includes propylene.

3. The composition of claim 2, wherein the composition is 30-40 wt % C₂, 45-55 wt % C₃, 10-20 wt % para-methylstyrene derived units, and 0.5-2 wt % of the pendant alkoxy silane group, based on the weight of the copolymer.

4. The composition of claim 1, wherein the alkoxy silane group has the formula
RₙSiX₍₄₋ₙ₎,
R is an organic moiety that is an alkyl, aromatic, or combination thereof,
X is an alkoxy moiety, and
n is a whole number ranging from 1 to 3.

5. The composition of claim 4, wherein X is ethoxy.

6. The composition of claim 4, wherein X is methoxy or any alkoxy.

7. The composition of claim 1, wherein the substituted styrene compound is represented by the formula: 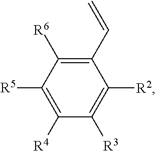
wherein each R², R³, R⁴, R⁵ and R⁶ is independently hydrogen or a C₁ to C₂₀ hydrocarbyl group, wherein at least one of R², R³, R⁴, R⁵ and R⁶ is not hydrogen.

8. A method, comprising:
combining ethylene, one or more α-olefins, and one or more substituted styrene compounds with n-BuLi, and then an chloroalkoxysilane, under reaction conditions, to form a copolymer bearing a pendant alkoxy silane group.

9. The method of claim 8, wherein the one or more substituted styrene compound includes para-methylstyrene, and the one or more α-olefins includes propylene.

10. The method of claim 8, wherein the chloroalkoxysilane is Cl—Si(OEt)₃.

11. The method of claim 8, further comprising at least partially curing the copolymer bearing pendant alkoxy silane groups in water.
